(19) United States
(12) Patent Application Publication
(10) Pub. No.: US 2007/0084764 A1
(43) Pub. Date: Apr. 19, 2007

(54) Bi-directional sort mechanism and method of use

(75) Inventor: David Benninger, Endwell, NY (US)

Correspondence Address: GREENBLUM & BERNSTEIN, P.L.C., 1950 ROLAND CLARKE PLACE, RESTON, VA, 20191, US

(73) Assignee: Lockheed Martin Corporation, Bethesda, MD (US)

(21) Appl. No.: 11/251,830

(22) Filed: Oct. 18, 2005

(51) Int. Cl. B07C 5/00

(52) U.S. Cl. 209/584

(57) ABSTRACT

An apparatus and method for stacking product in a container. The apparatus comprises a bi-directional conveying system configured to transport product to either end thereof. A container handling system is positioned proximate the bi-directional conveying system. The container handling system is configured to move empty containers proximate the ends of the bi-directional conveying system for sorting and/or sequencing of product therein and containers with product therein away from the bi-directional conveying system.

### FIELD OF THE INVENTION

The invention generally relates to a sorting mechanism and method of use and, more particularly, to a system and method for sorting product into containers in one of two sort destinations from a single unloading location.

### BACKGROUND DESCRIPTION

The sorting of mail is a very complex, time-consuming task. In general, the sorting of mail is processed through many stages and depths of sortation. The depth of sort ranges from course-sortation or 3-digit Zip Code (Zone Improvement Program code (USPS™) to Carrier-Walk or Delivery-Route Sequence. Automation exists today that sorts the entire letter mail steam to the Delivery-Route Sequence depth.

These sorting/sequencing processes can either be manual or automated, but automatically sequencing the letter-mail stream has saved the USPS millions of dollars annually. To automatically Delivery-Route Sequence a given mail steam the mail must first be processed to a depth-of-sort just above the Delivery-Route Sequence in a “first-pass” operation. During the first-pass operation the mail pieces all become a known set of data. Finally, the same mail is processed in a “second-pass” where it can be systematically placed in Delivery-Route Sequence.

The degree of automation depends on the mail sorting facility, the type of mail being sorted such as parcels, flats, letters and the like. A host of other factors may also contribute to the automation of the mail sorting, from budgetary concerns to modernization initiatives to access to appropriate technologies to a host of other factors.

In general, however, most modern facilities have taken major steps towards automation by the implementation of a number of technologies. These technologies include, amongst others, letter sorters and sequencers, parcel sorters, advanced container conveyors, flat (magazine-sized mail) sorters and the like. As a result of these developments, postal and other types of handling facilities have become quite automated over the years, considerably reducing overhead costs.

Although known automated systems have provided many benefits, there are still improvements that can be made in order to minimize costs and maximize efficiencies. For example, no flats automation has been developed that can sequence the flat-mail stream and provide the savings realized by letter-sequencing automation.

Flat mail represents about 25 percent of total mail volume and generates billions annually in USPS revenues. Last year, approximately 25 billion flats were not presorted for carrier delivery and were therefore more costly to process as they required additional sorting. The USPS Flat Strategy identifies initiatives to drive down the $4 billion annual cost associated with letter carriers spending nearly three hours daily sorting mail prior to making their rounds. Despite its name, flat mail varies greatly in size and shape, and is sorted on various machines or presorted by mailers to carrier routes.

Current flats-sorting/sequencing systems that have been considered for wide use in the USPS are limited in their sorting speed by their backbone configuration, such that it is physically impossible to process mail at sufficient backbone speeds to accomplish a second-pass before the daily dispatch time. With some systems the inability to achieve the dispatch time criteria is driven by futile attempts to incorporate existing sorting systems to accomplish first-pass and accomplish second-pass flats sequencing with new high-speed systems coupled to the existing systems. With other sequencing systems the inability to achieve the dispatch time criteria is mainly due to the significant changes in backbone direction and elevation over a short space.

In one known flats-sequencing system configuration, the sorter backbone is forced to make significant directional changes in a relatively small space, changing direction of travel by 180 degrees and changing elevation by nearly four feet. These significant directional changes result in the flat having to be transported at slower speeds in order to ensure that the flat remains within the flat-flat mail packet holders on the backbone during transport. A more direct race-track style backbone would remove the significant directional changes, but also double the machine footprint for the same number of dedicated sort destinations.

Another weakness of all flats-sorting/sequencing systems that have been considered for use in the USPS is that they deliver the flat into a dedicated flat mail container directly from their packet holders. Thus, the sort destination is unavailable while a full mail container is being exchanged for an empty mail container and the dedicated single-use sort destination is unavailable for this segment of the processing run.

Additionally, in known system configurations, flat mail containers or trays are loaded from a single side of the backbone. In one configuration, the empty containers are staged at a container staging area. At the coordination of a control system, the empty container is transported to a sort location, at which time the product is sorted into the container. Once the container is filled, the container is then transported away from the sort location so that another container can be placed in its stead. However, it may take upwards of two or more minutes to make such “swap” thus decreasing the sort destination availability and overall throughput of the system.

In one solution to the above problem, sorters have been designed to have an empty container staging area at one side of the backbone and a sorting area directly under the packet holders so that full mail trays exit the opposite side and can be exchanged in less time. Although this configuration can increase throughput, the overall machine footprint is increased thus utilizing a large amount of valuable floor space.

The invention is designed to overcome one or more of the above material handling problems, while it simultaneously doubles the available sort destinations.

### SUMMARY OF THE INVENTION

In a first aspect of the invention, an apparatus comprises a bi-directional conveying system configured to transport product to either end thereof. A transport system has a first sort destination area and a second sort destination area positioned proximate the first end of the bi-directional sort mechanism and the second end of the bi-directional sort mechanism, respectively. Each of the first sort destination area and the second sort destination area are configured to receive product from the bi-directional sort mechanism.

In another aspect of the invention, the apparatus includes a modular bi-directional transporting assembly configured to move product in either of two directions via a cross movement transport. A container handling system is positioned adjacent sides of the modular bi-directional transporting assembly and is configured to move containers toward and away from the modular bi-directional transporting assembly. The container handling system includes an upper tier comprising a first upper conveying system positioned at a first side of the modular bi-directional transporting assembly and a second upper conveying system positioned at a second side of the modular bi-directional transporting assembly. The lower tier comprises a first lower conveying system positioned below the first upper conveying system and a second lower conveying system positioned below the second upper conveying system.

In yet another aspect of the invention, a system for sorting mail includes a sorting system configured in a loop. The sorting system includes at least one feeder having equipment to obtain mail information and a backbone having a plurality of packet holders. The packet holders receive mail inducted from the at least one feeder. A bi-directional sort mechanism is located at each of the unloading locations. The bi-directional sort mechanism is configured to move the mail in either of two directions into a final sort destination. The bi-directional sort mechanism includes a transporting mechanism having a first end and a second end.

The sortation system also includes an upper tiered conveying system and a lower tier conveying system. A mechanism interconnects a transportation path of the upper tiered conveying system and the lower tier conveying system. A controller coordinates movement, based on the mail information, of:
the packet holders to certain unloading locations;
the transporting mechanism between a first direction toward the first end and a second direction toward the second end upon unloading of mail pieces thereon; and
the first and second upper conveying systems and the first and second lower conveying systems in order to move containers in position to receive the mail pieces sorted from the first end or the second end of the transporting mechanism and moving the containers away from the first end and the second end upon a fill, or other triggering, condition.

In yet another aspect of the invention, a system comprises a bi-directional sort mechanism having an unload area decoupled from at least one sort destination area. The unload area is configured to remain available to receive product regardless of the availability for processing the product to at least one sort destination area.

In another aspect of the invention, a method for sorting mail into a container on a first side of an assembly or a second side of the assembly. The method includes, with no order being implied:
moving an empty container into a transportation path of a first direction or a second direction of a transporting mechanism;
inducting mail into a feeder and obtaining information to be reconciled with an unload location and a sort destination;
transporting the mail to a determined unload location and unloading the mail onto the transporting mechanism associated with the unload location, based on the reconciled information, regardless of availability for processing the mail to at least one sort destination area.

In further embodiment, the method includes:
activating the transporting mechanism to transport the mail in one of the first direction or the second direction, depending on a final sort destination of the mail based on the reconciled information; and
transporting the container away from the transporting mechanism after the container has been either filled with product or the filling of which has otherwise been completed.

### BRIEF DESCRIPTION OF THE DRAWINGS

FIG. 1 shows a cross sectional view of an embodiment in accordance with the invention;

FIG. 2 shows a cross sectional view of an embodiment in accordance with the invention with one possible alternate mail container handling subsystem;

FIG. 3 shows a top view of a system in accordance with the invention; and

FIG. 4 shows steps implementing an embodiment in accordance with the invention.

### DETAILED DESCRIPTION OF EMBODIMENTS OF THE INVENTION

The invention is directed to a system and method for sorting and/or sequencing product in one of two sort destination areas using a single unload location. The product may be, for example, flats, parcels and other mail items (i.e., letters), for future delivery or warehousing or the like. The invention significantly reduces machine costs by allowing a single machine to sort flats and mail pieces or other disparate products, in embodiments, at two sort locations (sort destination areas) served by a single unload location. Other applications such as warehousing and storage applications are also contemplated for use with the invention.

In one aspect of the invention, the system reduces the use of valuable flooring space, while increasing the throughput of a sorter backbone. The invention further enables sorting in a continuous loop; that is, the bi-directional sort mechanism of the invention allows the system, e.g., sorter backbone, to operate in one continuous loop. The continuous loop provides for more gradual changes in direction and elevation, thus allowing the backbone to operate at higher speeds. Additionally, the invention reduces the sorter height, in embodiments, between one and three feet, and requires less length, e.g., in one embodiment, 60 feet less length, than a comparable sorting backbone manufactured by competitors. The system of the invention additionally decreases overall machine size and improves operator safety.

### SYSTEM OF THE INVENTION

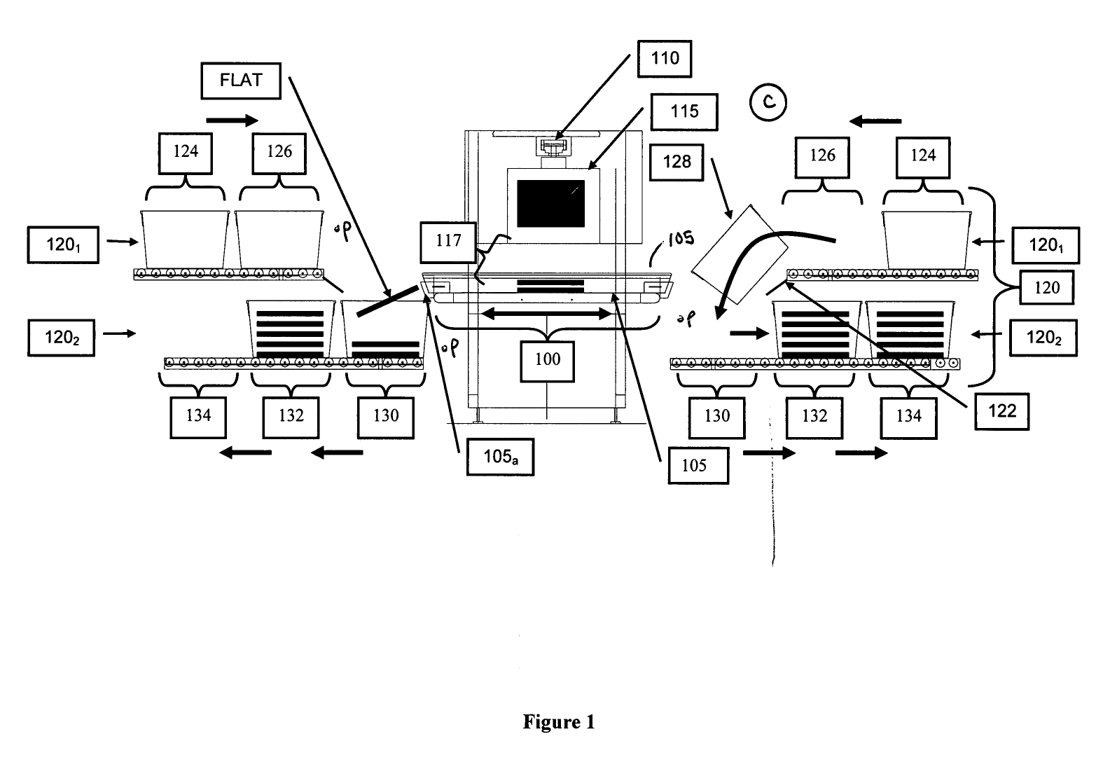

Referring now to FIG. 1, a modular bi-directional sort mechanism is shown generally at reference numeral 100. The bi-directional sort mechanism 100 includes, in one embodiment, a transport system 105 such as, for example, across belt conveying system or other transport such as active rollers positioned beneath packet holders 115 being moved by mechanical attachment to a backbone 110 of a sorting system. In an alternate embodiment, the transport system 105 may include, for example, a tip chute or any other mechanism which allows product, once unloaded onto the bi-directional sort mechanism 100, to traverse to one of two sort destination areas on either side of the bi-directional sort mechanism 100.

The backbone 110 includes a packet holder 115, capable of holding, transporting and then releasing product to the transport 105. The backbone 110 and the packet holder 115 are well known in the field of integrated sorting and sequencing system such as those manufactured by Lockheed Martin Corporation.

On each side of the bi-directional sort mechanism 100 is a container supply and takeaway system, e.g., conveying system 120, which is designed primarily to bring empty containers to either side of the bi-directional sort mechanism 100. The secondary purpose of the supply and takeaway system 120 is to take away full containers or swap containers at a predetermined time or upon certain events, e.g., fill tray condition. It should be understood that the container supply and takeaway system 120 may take a variety of different forms including, for example, a two-tiered system, a carousel system, an elevator system or any container (e.g., material) handling system capable of meeting the objectives stated herein.

In the example, of FIG. 1, a two-tiered conveyor system 120, including an upper level 120₁ and a lower level 120₂ capable of transporting containers, trays, bins, or other types of holders (generally referred to as containers) to and away from the sort destination 130 is shown. However, this illustrative example could be substituted by a variety of different container handling solutions and, as such, the representation of the two tiered system of FIG. 1 is to be considered as one solution and should be generally interpreted to include the above solutions and their equivalents.

Still referring to FIG. 1, the lower level 120₂ is positioned such that product being unloaded from the packet holder 115 can be transported from the transport mechanism 105 to a container located at a sort destination area 130 on the lower level 120₂. More specifically, the upper level 120₁ transports containers toward the sort destination area 130; whereas, the lower level 120₂ is used as a staging area to remove the filled containers and thereafter transport the containers in a direction away from the sort destination area 130. In an alternative embodiment, such as a carousel system, as the carousel rotates, containers can be transported towards and away from the sort destination area 130. At a certain time, the carousel can stop rotating in order to allowing the containers to be filled at the sort destination area 130.

In one embodiment, the upper level 120₁ may include a ramp, chute or other mechanism 122₁ which is designed to assist in transporting the containers from the upper level 120₁ to the lower level 120₂. The mechanism 122₁ is also designed to allow the container to be positioned adjacent or proximate to a lip 105a of the transport 105, as it is positioned onto the lower level 120₂. In the embodiment of FIG. 1, the lower level 120₂ extends beyond an end of the upper level 120₁ closest to the transport 105.

The upper level 120₁ includes an empty container supply area 124 and an empty container staging area 126. The empty container supply area 124 ensures that a container will always be ready to replace the container that was previously in the empty container staging area 126. Between the upper level 120₁, and the lower level 120₂ a container 128 is shown transitioning between an empty container staging area 126 and the sort destination area 130. Once the container has transitioned from the empty container staging area 126 to a sort destination area 130, the container can be filled.

Unlike previous systems where the unload location was unavailable while empty containers were transitioned into position, the present invention allows continuous processing, e.g., stacking, of the product at the unload location 117 during container swap, i.e., until the replacement container 128 has been positioned at the sort destination 130. Additionally, using the present invention, the unload location 117 always remains available regardless of whether a container is ready for filling. So, during the swapping of containers, using the present invention, it is now possible to continue unloading product from the packet holders thus increasing the overall throughput of the system. Moreover, as should be understood by those of ordinary skill in the art, the present invention removes one of the key bottlenecks of flat sortation, e.g., the unavailability of the sort destination.

Once the container is filled or ready to be moved from the sort destination area 130, depending on the parameters of the system, the container will be moved to a filled container staging area 132. The filled container staging area 132 provides a buffer between the sort destination area 130 and a filled container takeaway area 134 The filled container takeaway area 134 can be a separate conveying system, working independent, but in coordination with, the remaining transports of the lower level 120₂.

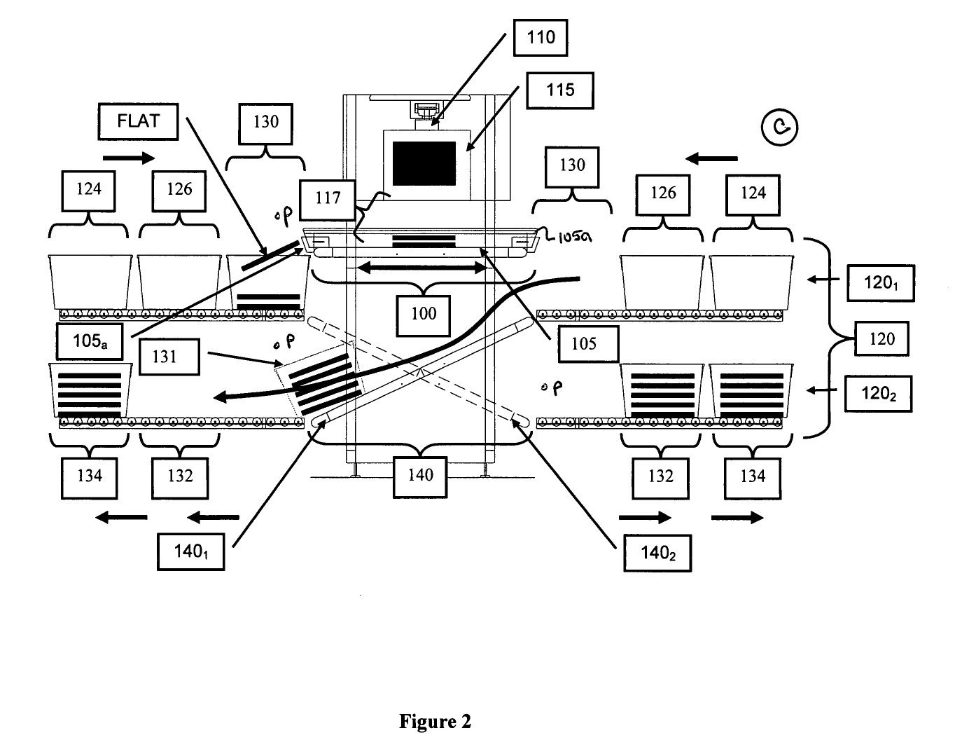

FIG. 2 shows a diagram of another embodiment in accordance with the invention. In the embodiment of FIG. 2, the bi-irectional sort mechanism, generally shown at reference numeral 100, includes a transport system 105, similar to the transport system 105 described above. By way of example, the transport system 105 may take the form of a cross belt conveying system, active rollers, a tip chute or any other mechanism which allows product, once unloaded onto the bi-directional sort mechanism 100, to traverse to one of two sort destination areas 130 on either side of the bi-directional sort mechanism 100.

In the example of FIG. 2, on each side of the bi-directional sort mechanism 100 is a two-tiered conveyor system 120, including an upper level 120₁ and a lower level 120₂ capable of transporting containers to and away from the sort destination area 130. Again, it should be recognized that this is only one illustrative example of a container handling system and other systems are also contemplated herein, such as those described above.

In FIG. 2, the upper level 120₁ is positioned such that product being unloaded from the packet holder 115 can be transported via the transport system 105 to a container located at one of two sort destination areas 130 on the upper level 120₁ as discussed in more detail below. In this configuration, the upper level 120₁ and the lower level 120₂ may be aligned with one another, from top to bottom.

Still referring to FIG. 2, the upper level 120₁ transports containers toward the sort destination areas 130; whereas, the lower level 120₂ transports the containers in a direction away from the sort destination areas 130. In one embodiment, each of the upper levels 120₁ at one side, is connected to respective lower levels 120₂ at the opposing side, by a tilting conveyor system 140. This conveying system may be a ramp or chute, for example.

In one illustration, a first tilting conveyor system 140₁ is shown connected to a first upper level and a first lower level; whereas, a second tilting conveyor system 140₂ is shown connected to a second upper level and a second lower level. The container is positioned adjacent or proximate to a lip 105a of the transport system 105, as it is positioned on the upper level 120₁.

Each upper level 120₁ includes an empty container supply area 124 an empty container staging area 126 and a sort destination area 130, the latter area being where the container can be filled. The sort destination area 130 is positioned at a height to allow a container to be positioned slightly below or at a lip 105a of the transport system 105. After product from the bi-irectional sort mechanism 100 fills the container at the sort destination area 130, the container is transported to the lower level 120₂ for transport away from the sort destination areas 130. A filled container 131 is shown as it transitions from the sort destination 130 to the filled tray staging area 132.

Referring now to both FIGS. 1 and 2, a photodiode or other sensor may be used to detect the presence or absence of a container within the loading and/or staging areas of the bi-directional sort mechanism 100. A photodiode or other sensor can also be used to determine a fill container condition. In one embodiment, an optional pressure sensor or photodiode may be positioned to detect the position of the container, as well as a full (or other) container condition. Alternatively, an encoder or other counting device can be used to determine a full container condition or the location of the container, all of which are well known in the art of handling systems. The sensor is generally depicted as “P” and is in communication with a controller “C”, for the coordination of the product and movement of the containers throughout the system (as discussed in more detail below).

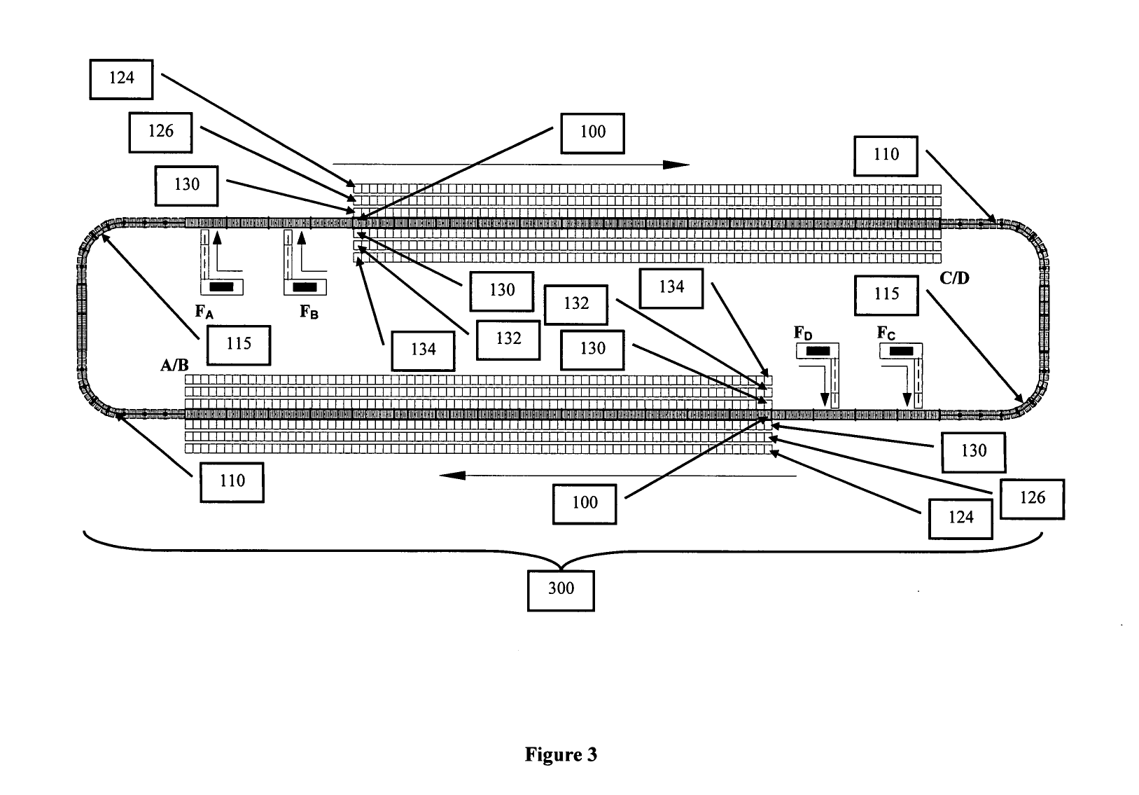

FIG. 3 represents an overall system 300 of the invention. In this representation, the embodiment of FIG. 1 will be discussed; however, it should be understood that the invention also contemplates the use of the embodiment of FIG. 2 or other variations discussed herein. In the embodiment of FIG. 3, a loop backbone 110 may be used in accordance with the invention with multiple physical or logical partition of bins associated with each feeder. In this loop system, due to the use of the bi-directional sort mechanism and related components, the backbone no longer requires radical changes in direction or elevation. For example, in accordance with the invention, the elevation change of the backbone can occur at each of the turns, and may gradually change from sort elevation, e.g., 48 inches, to an overhead height and back to feeder and sort elevations.

The gradual change in elevation will allow increased transporting speeds which, in turn, will permit a two pass sequencing (two pass sort) of the product in the time allotted by the United States Postal Service (USPS). In one embodiment, the speed of the backbone is only limited by the amount of product that can be physically unloaded from the packet holder. In one example, using four zones with 90 sort locations per zone, the speed of the system has the ability to process upwards of 52 thousand pieces of product per hour, which is a significant increase over known systems. Of course, this speed can increase with additional sorting zones.

In FIG. 3, four feeders F_{A}, F_{B}, F_{C} and F_{D} are shown, with feeders F_{A}, F_{B} on one side of the loop backbone 110 and feeders F_{C}, F_{D} on another side of the loop backbone 110. The feeder subsystems de-stack mail, singulate the mail pieces, acquire mail piece data, and insert the individual mail pieces or packages into one of a plurality of packet holders 115. The travel of product is in the clockwise direction, in this embodiment. Of course, depending on the particular application used with the system, more or less than four feeders and different travel directions can be used with the system. The product travels to appropriate sort destinations 130 along rows “A/B” and/or “C/D”.

The upper levels 120₁ and lower levels 120₂ are placed on each side of the backbone 110. For reasons of illustration and explanation, the upper level 120₁ is removed on the inner portion of the loop in order to show the lower level 120₂; however, it should be understood by those of skill in the art that the view of FIG. 3 would normally only show the upper level 120₁ (with the sort destination area 130 being seen, but the view of the filled container staging area 132 and the filled container takeaway area 134 being obstructed).

In implementation, product will be fed into each of the feeders F_{A} F_{B}, F_{C} and F_{D}. In one embodiment, product information will be obtained from the product, either by bar code scanners or optical reader scanners. The product information may also be manually obtained. In any of these situations, the product information will be provided to the controller “C”, via a network or other type of communication path, which will reconcile the information for future sorting and/or sequencing, in a well-known manner.

The product will then be inducted onto the backbone 110 and more specifically within a packet holder 115 or the like. The packet holder 115 will then transport the product to a specific unload location, where the product will be unloaded onto the bi-directional sort mechanism 100. It should be noted that, in this top view, most details of the bi-directional sort mechanism 100 are obstructed by the packet holders traveling at a higher elevation. By instruction of the controller, the bi-directional sort mechanism 100 will transport the product to one of two sort destination areas 130, depending on the product information.

In the first pass, the product can be unloaded into any of the sort destination areas associated with the rows “A/B” or “C/D”; however, in one embodiment, product may not initially be unloaded to a closest sort destination area with respect to the injecting feeder. For example, during first pass, a product that is fed from Feeder F_{A} and which is to be unloaded into a sort destination area along row “C/D” may first travel the entire loop prior to being unloaded to a location along row “C/D”, i.e., the row closest to the feeder F_{A}. This will provide a latency time of travel in order for the controller “C” to reconcile the product information with that of the unload location.

Once the product is unloaded from the packet holder, the controller “C” will instruct the bi-directional sort mechanism 100 to transport the product to one of two sort destination areas 130. The controller “C” will also control the movement of the trays throughout transport system 120, with the assistance of sensors, encoders, or container handling subsystem controllers.

In second pass, in one embodiment, the feeders F_{A}, F_{B} will be associated with sort destination areas along respective row “A/B” and feeders F_{C}, F_{D} will be associated with sort destination areas along row “C/D”. As way of illustration, a product that is inducted through feeder F_{A} will be unloaded to a sort destination area along row “A”. Again, once the product is unloaded from the packet holder, the controller “C” will instruct the bi-directional sort mechanism to transport the product to one of two sort destination areas, along either side of the backbone.

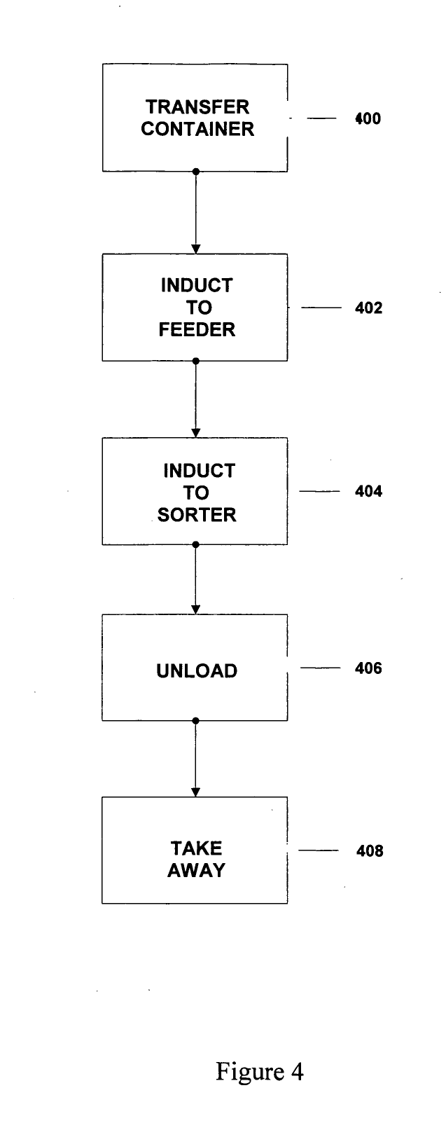

FIG. 4 shows steps implementing the embodiment of FIG. 1 or FIG. 2. The flow of FIG. 4 may equally represent a high level block diagram, representing the system of the invention. The steps of FIG. 4 may be implemented on computer program code in combination with the appropriate hardware. This computer program code may be stored on storage media such as a diskette, hard disk, CD-ROM, DVD-ROM or tape, as well as a memory storage device or collection of memory storage devices such as read-only memory (ROM) or random access memory (RAM). Additionally, the computer program code can be transferred to a workstation over the Internet or some other type of network. The steps of these figures are not limited to the sequence provided herein.

Referring to FIG. 4, at step 400, an empty container is transferred toward the backbone and, more specifically, adjacent the transport system. At step 402, the product is inducted into a feeder and the product information will be reconciled with an unload location. At step 404, the product will be inducted into the sorter and transported to the appropriate unload location. In a first pass, the product can be unloaded into any sort location; although, in one embodiment, the product could traverse the loop once if it is to be unloaded into any of the sort destination areas closest to the injecting feeder. This will provide time for the controller to reconcile the product information with the appropriate unload location. At step 406, the product will be unloaded onto the transport system of the bi-directional sort mechanism and, under instruction from the controller, the transport system will transport the product to a container on an appropriate side, e.g., sort destination area, of the bi-directional sort mechanism. The above steps can be performed in any order or simultaneously so long as a container is properly position prior to the product being inducted therein. Also, these steps will continue until the container(s) becomes full, which may be sensed by a photodiode, counter or other known mechanism.

At step 408, when a container becomes full, it is transported away from the bi-directional sort mechanism. Another container, in the empty container supply area, will then be moved to the sort destination area 130, where the container will be filled with product. By using both the empty tray staging area and full tray staging area, the tray transition time is thus significantly reduced. Additionally, during this swap of containers, the unload location remains available for continuous product processing regardless of whether a container is ready for filling. Accordingly, it is possible to continue unloading product from the packet holders thus increasing the overall throughput of the system. The entire process can continue until all of the products are sorted and/or sequenced.

While the invention has been described in terms of embodiments, those skilled in the art will recognize that the invention can be practiced with modification within the spirit and scope of the appended claims.

What is claimed is:

1. An apparatus, comprising:
a bi-directional sort mechanism configured to transport product to either a first end or a second end thereof; and
a transport system having a first sort destination area and a second sort destination area positioned proximate the first end of the bi-directional sort mechanism and the second end of the bi-directional sort mechanism, respectively, each of the first sort destination area and the second sort destination area configured to receive product from the bi-directional sort mechanism in unload sequence.

2. The apparatus of claim 1, wherein the transport system is a two tiered system configured to move empty containers proximate the first end and the second end of the bi-directional sort mechanism to receive the product and away from the bi-directional sort mechanism system after the product has been received therein.

3. The apparatus of claim 2, wherein the two tiered conveying system comprises an upper tier and a lower tier and a mechanism for transferring the containers from the upper tier to the lower tier.

4. The apparatus of claim 2, wherein:
the two tiered conveying system includes an upper tier and a lower tier;
the upper tier includes a first upper conveying system and a second upper conveying system positioned proximate the first end and the second end of the bi-directional sort mechanism, respectively; and
the lower tier includes a first lower conveying system positioned below the first upper conveying system and a second lower conveying system positioned below the second upper conveying system.

5. The apparatus of claim 4, further comprising:
a mechanism for transporting the containers with product from a sort destination area of the first upper conveying system to a filled stage area of the second lower conveying system; and
a mechanism for transporting the containers with product from a sort destination area of the second upper conveying system to a filled stage area of the first lower conveying system.

6. The apparatus of claim 4, further comprising a controller, wherein the bi-directional sort mechanism is configured to load product into the containers at sort destination areas of one of the first upper conveying system and the second upper conveying system under coordination of the controller.

7. The apparatus of claim 2, wherein:
the two tiered system includes an upper tier and a lower tier;
the upper tier includes a first upper conveying system and a second upper conveying system positioned above the transport system; and
the lower tier includes a first lower conveying system positioned in a first transportation path of the bi-directional sort mechanism at the first end thereof and a second lower conveying system positioned in a second transportation path of the bi-directional sort mechanism at the second end.

8. The apparatus claim 7, further comprising:
a first mechanism configured to transport the empty containers from the first upper conveying system to a sort destination area of the first lower conveying system for loading product therein by the bi-directional sort mechanism and;
a second mechanism configured to transport the empty containers from the second upper conveying system to a sort destination area of the second lower conveying system for loading product therein by the bi-directional sort mechanism.

9. The apparatus of claim 7, wherein the first and the second upper conveying systems are configured to move the empty containers to a sort destination area, which is proximate the bi-directional sort mechanism and the first and second lower conveying systems are configured to move the containers with product away from the bi-directional sort mechanism, the first and second lower conveying systems each additionally including a filled container staging area providing a buffer between the sort destination area and a filled container takeaway area.

10. The apparatus of claim 1, further comprising a controller coordinating movements of the bi-directional sort mechanism toward one of the first end and the second, and movements of the containers transported on the transport system from a staging area to a sort destination area to a filled container staging area thereby ensuring that containers are staged for filling with the product in the sort level sequence and are taken away from the bi-directional sort mechanism when determined.

11. The apparatus of claim 1, further comprising at least one sensor to determine a position and fill condition of the containers.

12. The apparatus of claim 1, wherein the bi-directional sort mechanism is modular and is configured to be retrofitted onto a backbone of a mechanism.

13. The apparatus of claim 1, wherein the product are mail pieces.

14. The apparatus of claim 1, wherein the transport system is a carousel or elevator type transport system.

15. The apparatus of claim 1, further comprising a sorting mechanism having a backbone with transportable packet holders, at least one feeder with accompanying scanning equipment for obtaining product information from the product that is fed into the feeder and placed into a respect one of the packet holders, and a controller for coordinating movement of the packet holders to certain drop off locations each associated with a bi-directional sort mechanism.

16. An apparatus for loading product into a container, comprising:
a modular bi-directional sort mechanism configured to move product to one of sort destination areas from a single unload position; and
a container handling system positioned adjacent sides of the modular bi-directional sort mechanism and configured to move containers toward the sort destination areas and away from the modular bi-directional sort mechanism.

17. The apparatus of claim 16, wherein the container handling system is a two tiered conveying system including:
an upper tier comprising:
a first upper conveying system including a sort destination area of the sort destination areas, the first upper conveying system positioned at a first side of the modular bi-directional sort mechanism; and
a second upper conveying system including a sort destination area of the sort destination areas, the second upper conveying system positioned at a second side of the modular bi-directional sort mechanism; and
a lower tier comprising a first lower conveying system positioned below the first upper conveying system and a second lower conveying system positioned below the second upper conveying system.

18. The apparatus of claim 17, further comprising a mechanism configured to interconnect the two tiered conveying system and for transporting containers with product therein from:
the sort destination area of the first upper conveying system to a filled container staging area of the second lower conveying system; and
the sort destination area of the second upper conveying system to a filled container staging area of the first lower conveying system; and
the first upper conveying system and the second upper conveying system are positioned in a transportation path of the modular bi-directional transporting assembly.

19. The apparatus of claim 17, wherein the first lower conveying system and the second lower conveying system each include a sort destination area of the sort destination areas, the sort destination areas are positioned in a transportation path of the modular bi-directional sort mechanism.

20. The apparatus of claim 16, further comprising a controller coordinating movement of the modular bi-directional sort mechanism to transport product to either of the sort destination areas on one side or another side thereof and movements of containers on the transporting system to ensure that at least containers are staged in the sort destination areas for filling with the product on respective sides of the bi-directional sort mechanism, and to be taken away from the bi-directional sort mechanism when determined.

21. The apparatus of claim 16, further comprising at least one sensor to determine a position and fill condition of the containers.

22. The apparatus of claim 16, wherein the product are mail pieces.

23. A system for sorting mail, comprising:
a sorting mechanism configured in a loop, the sorting mechanism including:
at least one feeder having equipment to obtain mail information; and
a backbone having a plurality of packet holders, the packet holders receiving mail inducted from the at least one feeder;
a modular bi-directional sort mechanism located at each of the unloading locations, the modular bi-directional sort mechanism configured to move the mail to one of two sort destination areas;
a transporting mechanism having a first destination sort area and a second destination sort area positioned with respect to each end of the modular bi-directional sort mechanism and
a controller for coordinating movement, based on the mail information, of:
the packet holders to certain unloading locations associated with each modular bi-directional sort mechanism;
the modular bi-directional sort mechanism to a first direction toward the first destination area and a second direction toward the second destination area; and
the transporting mechanism to move containers to and away from the first and second sort destination areas.

24. The system of claim 23, wherein the transporting system comprises:
an upper tiered conveying system comprising a first and second conveying system positioned at a first and second side of the modular bi-directional sort mechanism, respectively,
a lower tiered conveying system comprising a first lower conveying system positioned below the first upper conveying system and a second lower conveying system positioned below the second upper conveying system; and
the controller controlling the first and second conveying system of the upper tiered conveying system and the first and second conveying systems of the lower tiered system in order to move containers to the sort destination areas and moving the containers away form the sort destination areas.

25. A system comprising a bi directional sort mechanism having an unload area decoupled from at least one sort destination area, the unload area configured to remain available to receive product regardless of the availability for processing the product to at least one sort destination area.

26. The system of claim 25, wherein the bi-directional sort mechanism includes a transport system and to at least one sort destination, defined as a first sort destination area and a second sort destination area positioned proximate a first end and a second end of the bi-directional sort mechanism, respectively, each of the first sort destination area and the second sort destination area configured to receive product from the unload area.

27. The system of claim 25, further comprising a controller coordinating movement of the bi directional sort mechanism to load product from the unload area into the containers at the sort destination areas at one of two ends of the bi-directional sort mechanism.

28. The system of claim 27, wherein the controller coordinates movement of the containers transported on a transport system from empty container staging areas to the sort destination areas to filled container staging areas thereby ensuring that containers are staged for filling with product and are taken away from the bi-directional sort mechanism when determined.

29. A method of sorting mail into a container on a first side of an assembly or a second side of the assembly, comprising:
moving an empty container into a transportation path of a first direction or a second direction of a transporting mechanism;
inducting mail into a feeder and obtaining information to be reconciled with a unload location; and
transporting the mail to a determined unload location and unloading the mail onto the transporting mechanism associated with the unload location, based on the reconciled information, regardless of availability for processing the mail to at least one sort destination area.

30. The method of claim 29, further comprising:
activating the transporting mechanism to transport the mail in one of the first direction or the second direction, depending on a final destination of the mail based on the reconciled information; and
transporting the container away from the transporting mechanism after the containers have been loaded with product.
